(19) United States
(12) Patent Application Publication
(10) Pub. No.: US 2017/0202254 A1
(43) Pub. Date: Jul. 20, 2017

(54) PASTA FOOD PRODUCT WITH MICRO-HOLES, METHOD AND APPARATUS FOR PRODUCING IT

(71) Applicant: Nadia PERANTONI, Fumane (IT)

(72) Inventor: Nadia PERANTONI, Fumane (IT)

(21) Appl. No.: 15/329,144

(22) PCT Filed: Jul. 24, 2015
(86) PCT No.: PCT/IB2015/055611

§ 371 Date: Jan. 25, 2017

(30) Foreign Application Priority Data
Jul. 25, 2014 (IT) VR2014A000192

(51) Int. Cl. A23L 7/109; A21C 11/12

(52) U.S. Cl. CPC A23L 7/109; A21C 11/12; A23V 2002/00

(57) ABSTRACT

This disclosure relates to a pasta food product (1, 2, 20), having a wall (11) or a body (21) of semolina or flour as the basic ingredient. The wall (11) or the body (21) have a surface (13, 23) and a thickness (S). The wall (11) or the body (21) have a plurality of micro-holes (18, 28) which extend in said thickness (S) and open on said surface (13, 23). The pasta food product (1, 2, 20) is a pasta that cooks quickly. This disclosure also relates to a production method and an apparatus for producing the pasta food product (1,2, 20).

This disclosure relates in general to the sector of food products. Specifically it relates to a pasta food product and an apparatus for producing it. Consumption of pasta, in a wide variety of formats and types, is widespread at least in several countries.

Pasta normally has semolina or flour as the basic ingredient, usually obtained from grains such as wheat, durum wheat, rice. Pasta is obtained starting with a dough made of water, semolina or flour, and any other ingredients necessary (for example, eggs). The dough is worked and shaped, for example it is rolled out into a sheet of rolled pasta dough or it is extruded or drawn through a mould. Then the dough is cut into pieces, to obtain products having a desired shape, for example: spaghetti, penne (quills), eliche (twists), tagliatelle (ribbons), etc.

To obtain a dried pasta, the products are subjected to a drying step in suitable machinery.

When the time comes to eat them, pasta food products are cooked by boiling them, that is to say, they are cooked in boiling water for a predetermined time.

During cooking, the water penetrates the thickness of the pasta and is absorbed into the product, softening it. Moreover, the boiling water which strikes the surface of the product transfers heat to the surface, from where the heat is diffused into the entire mass of the product, causing a chemical-physical transformation which makes the product digestible.

This process of absorption and diffusion requires a cooking time which may vary considerably from case to case. The cooking time depends on the thickness of the product, its shape and the degree of drying. The cooking time of pasta food products is usually between 5 minutes and 12 minutes.

In some situations where dishes must be served with the shortest possible waiting time, for example in the catering and canteen sector, a long cooking time may be inconvenient for consumers and difficult for operators to manage.

Therefore, there is a general need to reduce the cooking times of pasta food products as far as possible.

Many solutions are currently used, but none of them is satisfactory as regards all aspects.

For example, there are pasta products for sale that cook quickly and are made less thick than normal products. The reduced thickness speeds up the processes of water absorption and heat diffusion which occur during cooking and therefore reduces the cooking times. However, the reduction in thickness also significantly affects the consistency and mechanical strength of the cooked product, with a general deterioration in the quality of the dish which is therefore less appreciated by the consumer.

Alternatively, in the catering sector it is normal to pre-cook a predetermined quantity of portions of pasta, which is partly cooked pending an order. Cooking of a portion is completed only when a customer orders a plate of pasta. Therefore, the preparation time for that plate of pasta depends on the time needed to finish the cooking, rather than the complete cooking time required. However, pre-cooked pasta loses its quality characteristics during the wait, more so the longer the wait. Moreover, unused pre-cooked pasta becomes waste, with an obvious amount of waste if orders of plates of pasta were much lower than the initial estimate. In any case, pre-cooking pasta involves considerable organisational complexity.

This disclosure starts from the technical problem of providing a pasta food product that has short cooking times and that overcomes the above-mentioned disadvantages of the prior art and/or provides further advantages. That is achieved by supplying a pasta food product according to independent claim 1. The technical problem is also solved by a production method for a pasta food product according to claim 7 and by an apparatus for producing a pasta food product according to claim 9.

Particular embodiments of the subject matter of this disclosure are defined in the corresponding dependent claims.

One aspect forming the basis of the solution proposed by this disclosure is that of providing a pasta food product with micro-holes made in it, that is to say, a product having a plurality of micro-holes or micro-perforation extending in the thickness of the pasta and which open on the surface of the pasta.

The term “micro-holes” or “micro-perforations” does not necessarily mean that they have micrometric dimensions. The term should be understood in the sense that they are holes or perforations with small dimensions and are almost imperceptible to the naked eye.

In practice, a product according to this disclosure is a micro-holed pasta, fresh or dried, which is prepared with grains or has grains as the basic ingredients. The subject matter of this disclosure is generally applicable to a pasta prepared using any type of grain and is not limited to a specific grain. It is possible to use any type of grain, for example wheat, durum wheat, rice, maize, tapioca, etc.

Basically, said micro-holes are openings, slits or channels in the thickness of the pasta, that is to say, in the mass of the pasta. That is useful because, during product cooking, the boiling water penetrates said micro-holes and, already being in the thickness of the product, is more easily absorbed. Even heat transfer is more effective because it occurs on a larger surface area.

In practice, the micro-holes increase the surface area for heat and mass transfer between the pasta product and the surrounding water during cooking by boiling at the time of consumption: the transfer surface area is not limited just to the outer surface of the product, but also extends inside the product thanks to the micro-holes. The micro-holes themselves are small, but they are present in large numbers and therefore their total surface area is considerable.

Moreover, since the micro-holes are distributed substantially regularly in the product, the diffusion paths that the water and the heat must follow within the mass of the product are much shorter than what occurs for known products having the same dimensions.

Therefore, the cooking time is significantly reduced. For example, the cooking time for micro-holed pasta may be approximately 1 or 2 minutes. Therefore, it is a pasta that cooks quickly.

That is achieved without the need to reduce the product thickness and therefore without altering the consistency of the cooked product. The micro-holes have small dimensions, for example they have a diameter of between 0.1 mm and 1 mm (in particular between 0.1 mm and 0.6 mm, for example approximately 0.5 mm), and therefore, in terms of consistency and tastiness, they have no effect that can be perceived by the consumer. Moreover, during cooking the mass of the product tends to expand and therefore said micro-holes at least partly close gradually as the product is cooked. As a result, they are substantially undetectable in the cooked product.

In one embodiment, the product is a dried pasta having any format (spaghetti, quills, twists, shells, etc.), made with eggs if necessary.

In another embodiment, the product is a fresh pasta such as a sheet of pasta dough or is a fresh pasta obtained from a sheet of pasta dough, such as tagliatelle (ribbons).

The micro-holes are made in the product during the production step, in particular before a final product drying step, if required.

In practice, the micro-holes are made when the product is in a sufficiently solid state to maintain its shape, but in which it still has a certain degree of workability and doughiness which allows a micro-holing method to be implemented without breaking the product. In particular, the micro-holes are made after a thermal treatment step which stabilises the products to prevent them from sticking together.

In one embodiment, the micro-holes are made using a device comprising a support element and a plurality of needles which are mounted on the support element. The needles are spaced from each other and extend from the support element: the tips of the needles define a face having a plurality of spikes designed to perforate the product. The micro-holes are obtained by pressing the device on the surface of the product, in such a way that the needles penetrate the thickness of the product and produce corresponding micro-holes.

In one embodiment the needles are heated, for example to a temperature of 90-100° C. That is useful because each heated needle creates a local drying in the respective micro-hole as the micro-hole is being made. In practice, the heat of the needle locally “cooks” the pasta and stiffens the walls of the micro-hole, so that the micro-hole retains its shape and does not close during the subsequent working steps.

The subject matter of this disclosure can be applied in all contexts in which there is a need to speed up the preparation of a pasta-based dish. For example, one application sector is catering in public premises and in canteens. Another application sector is that of food vending, in which a vending machine prepares a dish selected by a user, without any persons intervening to prepare said dish. The use of a pasta that cooks quickly in this sector is particularly advantageous, both because people do not usually want to wait for long periods in front of a vending machine, and because it allows a larger number of dishes to be sold in the unit of time and reduces the formation of queues in front of the vending machine.

Further advantages, characteristics and methods for use of the subject matter of this disclosure are apparent in the following detailed description of non-limiting embodiments thereof, presented by way of example only.

In any case, it is evident how each embodiment may have one or more of the advantages listed above. In any case, each embodiment does not have to simultaneously have all of the advantages listed.

Reference will be made to the accompanying drawings, in which:

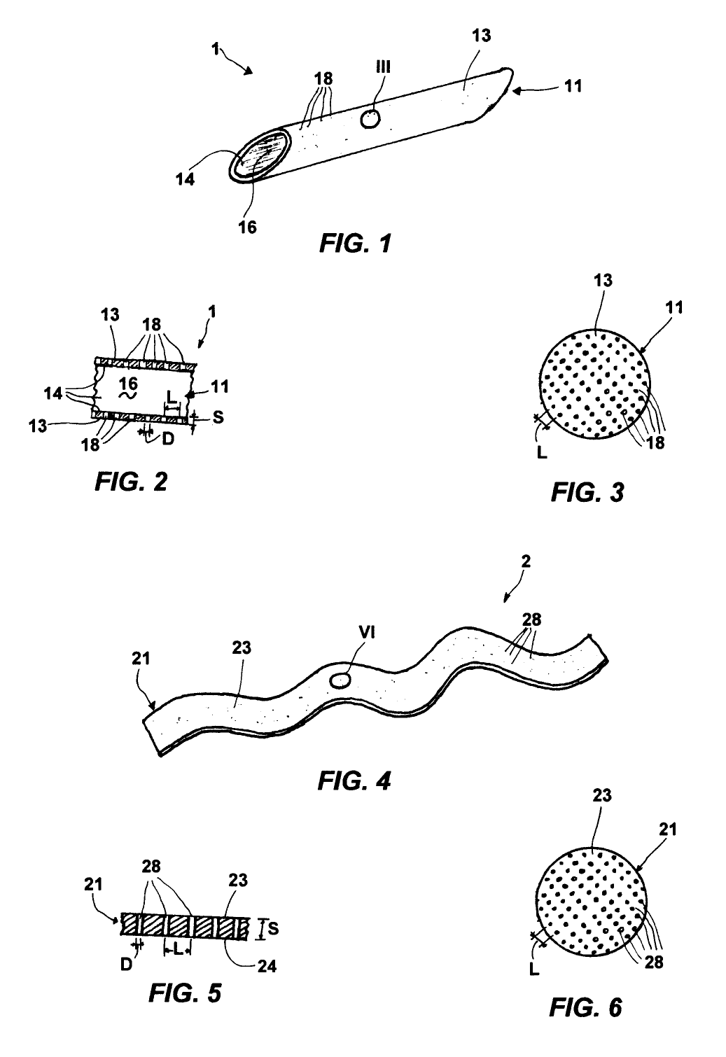

FIG. 1 is a perspective view of a pasta food product according to this disclosure;

FIG. 2 is an enlarged cross-section view of a part of the product of FIG. 1;

FIG. 3 is an enlarged view of a detail III of the product of FIG. 1;

FIG. 4 is a perspective view of another embodiment of a pasta food product according to this disclosure;

FIG. 5 is an enlarged cross-section view of a part of the product of FIG. 4;

FIG. 6 is an enlarged view of a detail VI of the product of FIG. 4;

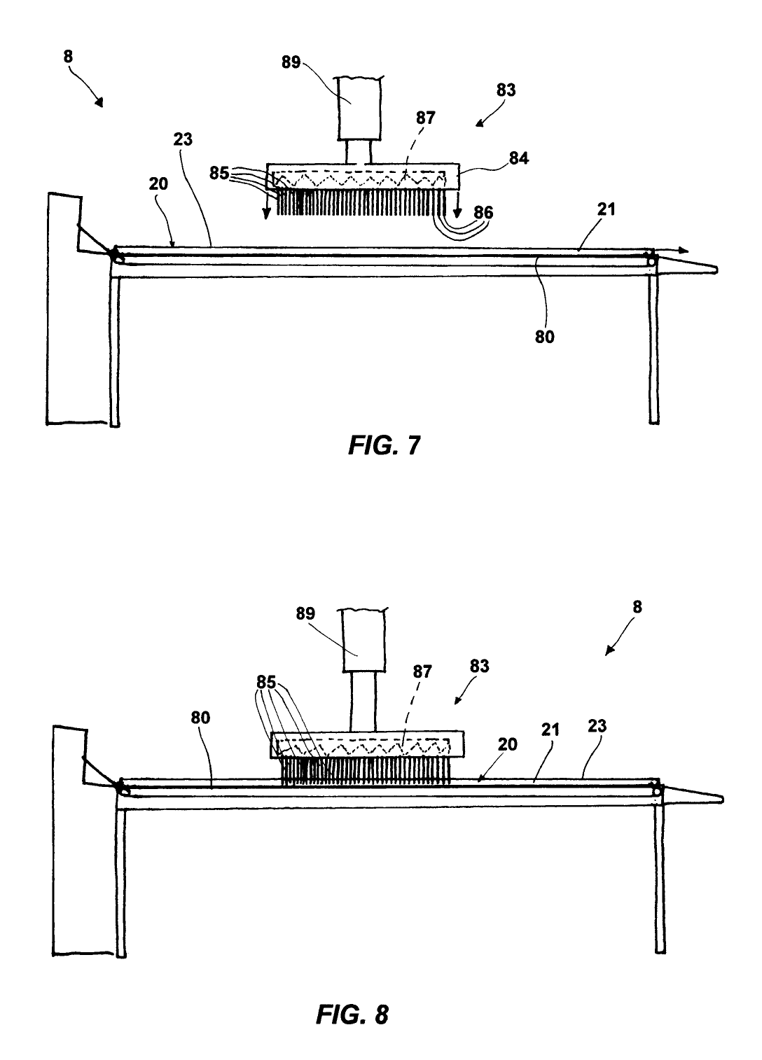

FIG. 7 is a side view of a micro-holing station, which is part of an apparatus for producing a pasta food product according to this disclosure, in a rest condition;

FIG. 8 is a side view of the micro-holing station of FIG. 7, in an operative condition;

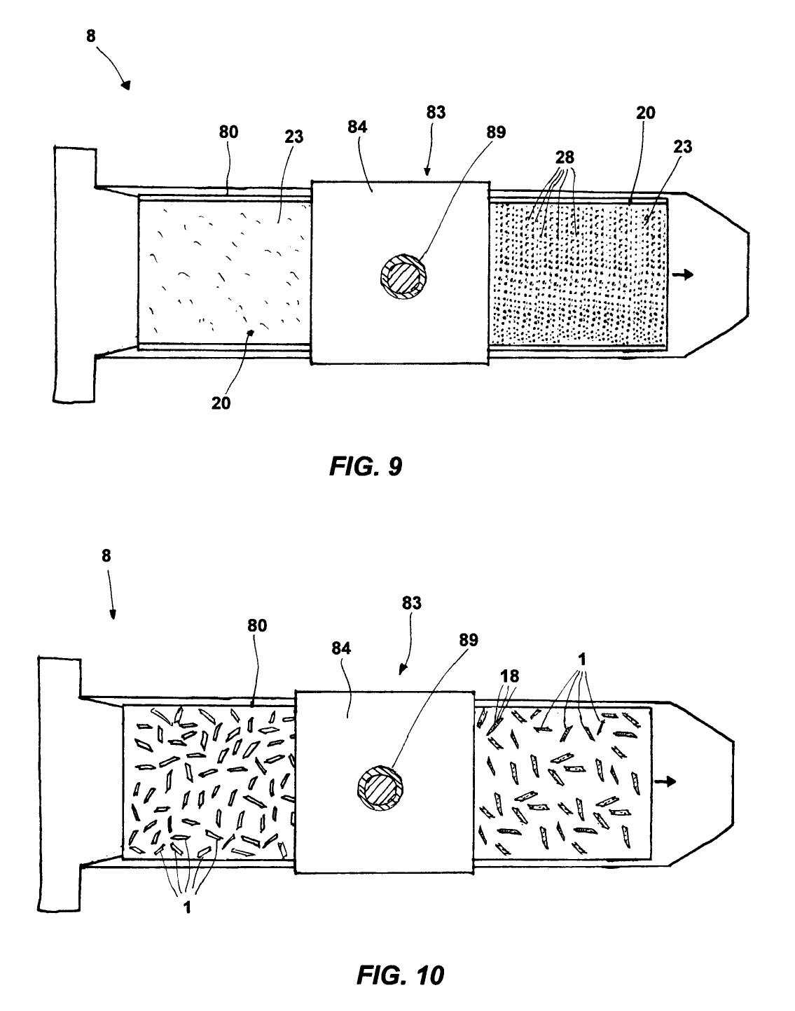

FIG. 9 is a top view of the micro-holing station of FIG. 7, during a step of working of products of FIG. 4;

FIG. 10 is a top view of the micro-holing station of FIG. 7, during a step of working of products of FIG. 1;

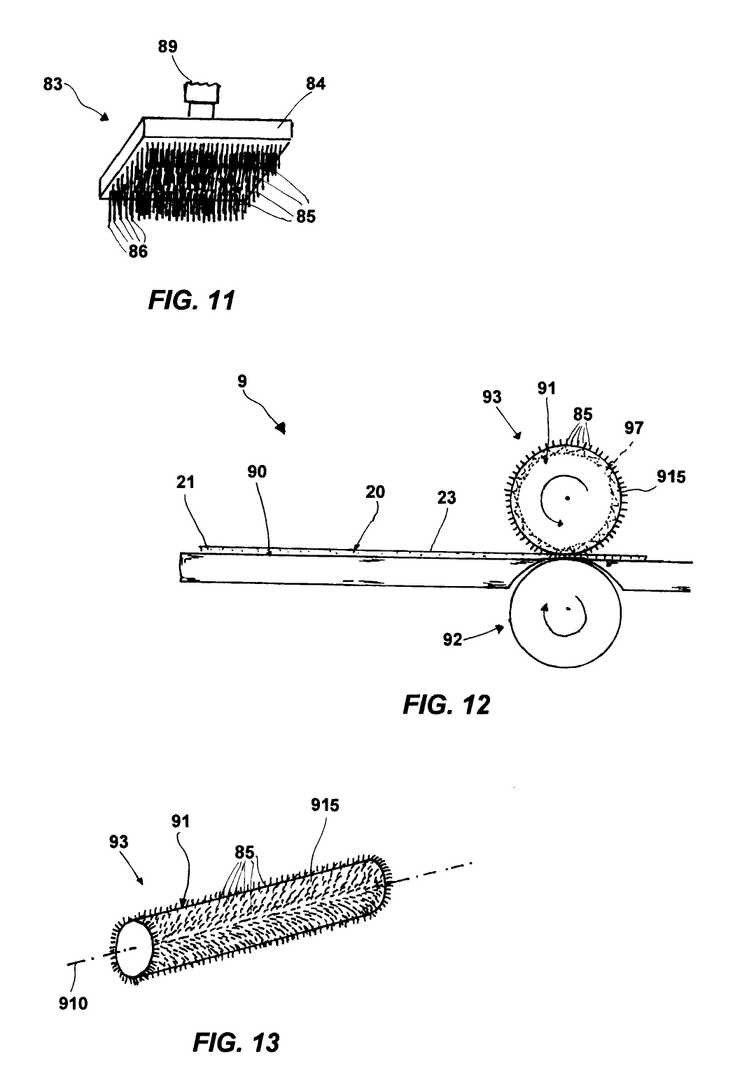

FIG. 11 is a perspective bottom view of a component of the micro-holing station of FIG. 7;

FIG. 12 is a side view of an alternative embodiment of a micro-holing station according to this disclosure;

FIG. 13 is a perspective view of a component of the micro-holing station of FIG. 12.

A first embodiment of a pasta food product according to this disclosure is shown in FIG. 1 and is labelled with the numeral 1. Specifically, the product 1 is a dried pasta, in particular with durum wheat semolina as the basic ingredient. In other embodiments the product 1 is made of other ingredients, for example, having flour as the basic ingredient.

The dried pasta product 1 is intended to be cooked by boiling, that is to say, cooked in boiling water, in the same way as prior art dried pasta products.

By way of example only, the dried pasta product 1 is in a format commonly referred to as “penna” (quill), but obviously other formats are possible.

The dried pasta product 1 has a body formed by a wall 11 which is made of pasta. Therefore, in the example, the wall 11 has durum wheat semolina as the basic ingredient.

The wall 11 delimits an inner cavity 16. The wall 11 has an outer surface or outer face 13 and an inner surface or inner face 14 which faces the inner cavity 16. The wall 11 has a thickness S between the outer surface 13 and the inner surface 14.

Moreover, in a pasta food product 1 according to this disclosure, the wall 11 comprises a plurality of micro-holes 18 which extend in the wall 11, that is to say, which extend in the thickness of the wall 11. The micro-holes 18 open on the outer face 13 of the wall 11 and pass through the entire thickness of the wall 11 until they also open on the inner surface 14.

Alternatively, the micro-holes 18 could only extend through part of the thickness, without reaching the surface opposite that on which they open. If necessary, the micro-holes 18 may only open on the inner surface 14.

In practice, the micro-holes 18 are tiny holes or channels with small dimensions which extend in the mass of the wall 11, substantially perpendicular to the outer surface 13, forming small open cavities on at least one surface 13 of the wall 11.

The micro-holes 18 are distributed in the entire wall 11, in a substantially uniform way on the surface 13. For example, they are distributed on a square-pattern grid. An enlarged portion of surface 13 is shown in FIG. 3. For example, the micro-holes 18 are made using sharp bodies such as needles or pins and therefore they have a corresponding diameter. For example, each micro-hole 18 has a diameter D which is between 0.1 mm and 1 mm. In particular, the diameter D of the micro-holes 18 is between 0.1 mm and 0.6 mm, for example it is approximately 0.5 mm.

The micro-holes 18 are spaced from each other with a distance or spacing L between two adjacent micro-holes 18 that is less than 3 mm. In particular, the spacing L is approximately 2 mm. The spacing L is measured between the centres of the adjacent micro-holes.

During cooking of the pasta food product 1, the boiling water in which the product 1 is boiled penetrates the micro-holes 18 through the openings on the surface 13.

Therefore, the transfer of heat and water to the mass of pasta of the product 1 occurs not just through the outer surface 13 and the inner surface 14, but also through the lateral surfaces of the micro-holes 18.

Thanks to this, the product 1 is cooked much more quickly. For example, a portion of products 1 in the quill format may be cooked in approximately two minutes from when the dried products 1 are thrown into the boiling water. Therefore, the product 1 is a pasta that cooks quickly.

A second embodiment of a pasta food product according to this disclosure is shown in FIG. 4 and is labelled with the numeral 2. Specifically, the pasta product 2 is a fresh pasta, in particular with wheat flour as the basic ingredient and is obtained from a sheet of pasta dough. If necessary, it may have semolina or other ingredients as the basic ingredients.

The fresh pasta product 2 is intended to be cooked by boiling, that is to say, cooked in boiling water, in the same way as prior art fresh pasta products.

By way of example only, the fresh pasta product 2 is in a format commonly referred to as “tagliatelle” (ribbon), but obviously other formats are possible. The product 2 has an elongate body 21, substantially a strip with limited thickness. The body 21 is made of pasta, in particular with flour as the basic ingredient.

The body 21 has a first surface or face 23 and a second surface or face 24, opposite the first surface 23. The body 21 has a thickness S between the first surface 23 and the second surface 24.

Similarly to what is described above for the dried pasta product 1, the body 21 of the fresh pasta product 2 has a plurality of micro-holes 28 which extend in the body 21, that is to say, they extend in the thickness of the body 21. The micro-holes 28 open on the first surface 23 of the body 21 and pass through the entire thickness of the body 21 until they also open on the second surface 24.

Alternatively, the micro-holes 28 may only extend through part of the thickness, without reaching the surface opposite that on which they open.

In practice, the micro-holes 28 are tiny holes or channels with small dimensions which extend in the mass of the body 21, perpendicular to the surfaces 23, 24, and form small open cavities on at least one surface 23 of the body 21.

The micro-holes 28 are distributed in the entire body 21, in a substantially uniform way on the surface 23. For example, they are distributed on a square-pattern grid. An enlarged portion of surface 23 is shown in FIG. 6. As regards the diameter D of the micro-holes 28 and their spacing L, and also as regards their purpose and their interaction with the boiling water during cooking of product 2, reference is made to what is described above for the micro-holes 18, with which they are substantially similar.

Again in this case, cooking of the product 2 which is much quicker than the prior art is achieved. For example, the cooking time is between one minute and two minutes.

The production method for a pasta product 1, 2 starts with a dough having semolina or flour as the basic ingredient, depending on the type of product to be obtained and the desired characteristics.

The dough is worked to form a product that has a body 21 or a wall 11 made of that dough. These initial steps are carried out substantially in the same way as for the prior art.

Then the plurality of micro-holes 18, 28 is made in the body 21 or in the wall 11 of the product, in such a way that the micro-holes extend in the thickness and open on a surface of the body or wall.

The micro-holes are made before a final step of at least partly drying the product 1, 2. Said final drying step is carried out just before packaging.

In other words, the micro-holes are made when the product is still workable to the extent that holes can be made without breaking the product. For example, the production method involves a thermal treatment step which partly cooks or dries the product, making it stable and not sticky, but without producing a dry, hard product. The micro-holes are made just after said thermal treatment step.

A production apparatus according to this disclosure comprises a micro-holing station 8, as shown in FIGS. 7 to 10.

The micro-holing station 8 comprises a support base 80 for the product and a micro-holing device 83. For example, the support base 80 is or comprises a conveyor belt which receives the product from a previous working station and, after having made the product pass through the micro-holing station, sends it on to the subsequent steps as far as packaging.

The micro-holing device 83, shown in detail in FIG. 11, comprises a support element 84 and a plurality of needles 85 which are mounted on the support element 84. The needles 85 extend from the support element 84 in such a way that the tips 86 of the needles 85 define a surface or face having a plurality of micro-perforating spikes for the pasta product. In particular, the needles 85 are arranged in a regular grid, for example spaced 2 mm from each other. Therefore, the micro-holes are separated by a distance or spacing L with the same value as the distance between the needles 85. For example, the needles 85 have 0.5 mm diameter and allow micro-holes which have a substantially similar diameter D to be obtained.

The micro-holing device 83 is designed to drive the needles 85 into the pasta food product, making the micro-holes.

In the embodiment shown in FIGS. 7 to 10, the micro-holing device 83 is movable between a rest position, in which the needles 85 are away from said support base 80 as shown in FIG. 7, and an operative position, in which the needles 85 are near to the support base 80 as shown in FIG. 8. The movement of the micro-holing device 83 between the two positions is driven for example by a hydraulic cylinder 89.

FIGS. 7 to 9 show a step of making micro-holes in a sheet of pasta dough 20, from which for example the fresh pasta products 2 will be obtained.

The sheet of pasta dough 20 is fed forwards by the conveyor belt on the support base 80. When the region of sheet of pasta dough 20 to be treated is below the micro-holing device 83 in the rest position, the conveyor belt is stopped and the micro-holing device 83 is lowered towards the support base 80 into the operative position. The tips 86 of the needles 85 penetrate the sheet of pasta dough 20 and create the micro-holes 28. Then, the micro-holing device 83 is returned to the rest position and the sheet of pasta dough 20 is fed forward another stretch.

In the embodiment illustrated, the micro-holing device 83 comprises a heating system 87, for example using an electrical resistance heating element, which heats the needles 85. For example, the needles 85 are heated to a temperature of around 90-100° C.

When the heated needles 85 penetrate the sheet of pasta dough 20, they locally heat the lateral walls of the micro-holes and, in practice, locally cook the pasta. In other words, the heat of the needle 85 creates a local drying of the body 21 or of the wall 11 of the product, at a respective micro-hole 18, 28.

That is useful for giving the micro-holes firmness, guaranteeing that the packaged product 1, 2 still has said micro-holes. Since the lateral walls cooked by the heated needles 85 are rigid and hard, the micro-holes do not collapse on themselves (that is to say, they do not close) during the subsequent working steps.

As shown in FIG. 10, the same apparatus, and in particular the same micro-holing station 8, may also be used for making micro-holes in the dried pasta products 1. In this case, the dried pasta products 1 are distributed on the conveyor belt and are fed forwards by the latter towards the micro-holing station 8 and beyond.

If necessary, a grille or net (not shown) may be positioned parallel to the support base 80 and above the products 1, 2, in a position interposed between the support base 80 and the micro-holing device 83.

The grille or net allows the needles 85 to pass, but prevent the products 1, 2 from passing if they remain attached to the needles 85 and are dragged upwards when the micro-holing device 83 returns to the rest position.

Another embodiment of a micro-holing station is shown in FIG. 12, in which it is labelled with the numeral 9. This micro-holing station 9 is particularly suitable for working a sheet of pasta dough 20.

The micro-holing station 9 comprises a support base 90, if necessary provided with a conveyor belt, and two cylindrical rollers 91, 92 which are parallel to each other and spaced from one another. The distance between the lateral surfaces of the rollers 91, 92 is approximately the same as the thickness of the sheet of pasta dough 20. The rollers 91, 92 are rotatable about respective longitudinal axes of rotation and rotate in opposite directions. The sheet of pasta dough 20 passes between the two rollers 91, 92. At least a first roller 91 of the two has a plurality of needles 85 projecting radially from its lateral surface 915, on which the needles 85 are distributed in a regular fashion. For example, the needles 85 are spaced 2 mm from each other to obtain micro-holes 28 separated by a corresponding distance or spacing L.

In other words, a micro-holing device 93 comprises the first roller 91 and the needles 85. The first roller 91 is a support element for the needles 85, which extend radially from the lateral surface 915 of the first roller 91.

As the sheet of pasta dough 20 passes between the two rollers 91, 92, the first roller 91 rotates about its longitudinal axis 910 and the needles 85 create the micro-holes 28 in the sheet of pasta dough 20.

The first roller 91 may comprise a heating system 97, for example using an electrical resistance heating element, which heats the needles 85 similarly to what was described relative to the micro-holing device 83.

The subject matter of this disclosure is described above with reference to its embodiments. It shall be understood that there may be other embodiments relating to the same inventive concept, all protected by the appended claims.

1. Pasta food product (1, 2, 20), having a wall (11) or a body (21) of semolina or flour as the basic ingredient, said wall (11) or said body (21) having a surface (13, 23) and a thickness (S),
wherein the wall (11) or the body (21) has a plurality of micro-holes (18, 28) which extend in said thickness (S) and open on said surface (13, 23).

2. Pasta food product (1, 2, 20) according to claim 1, wherein each of said micro-holes (18, 28) has a diameter (D) which is between 0.1 mm and 1 mm.

3. Pasta food product (1, 2, 20) according to claim 1, wherein said micro-holes (18, 28) are spaced from each other with a spacing (L) between two adjacent micro-holes (18, 28) that is less than 3 mm.

4. Pasta food product (1) according to claim 1, said pasta food product (1) being a dried pasta.

5. Pasta food product (2, 20) according to claim 1, said pasta food product being a sheet of pasta dough (20) or being obtained from a sheet of pasta dough (20).

6. Pasta food product (1, 2, 20) according to claim 1, said pasta food product (1, 2, 20) being intended to be cooked by boiling.

7. Production method for a pasta food product (1, 2, 20), comprising the steps of:
providing a dough having semolina or flour as the basic ingredient;
forming a product having a wall (11) or a body (21) of said dough, the wall (11) or the body (21) having a surface (13, 23) and a thickness (S);
making in the wall (11) or in the body (21) a plurality of micro-holes (18, 28) that extend in the thickness (S) and open on the surface (13, 23) of the wall (11) or of the body (21).

8. Production method according to claim 7, wherein the step of making the plurality of micro-holes (18, 28) is carried out through a plurality of heated needles (85), each heated needle (85) creating a local drying of the wall (11) or of the body (21) at a respective micro-hole (18, 28).

9. Apparatus (8, 9) for producing a pasta food product (1, 2, 20), including a micro-holing device (83, 93) for making a plurality of micro-holes (18, 28) in the pasta food product (1, 2, 20),
the micro-holing device (83, 93) comprising a support element (84, 91) and a plurality of needles (85) which are mounted on the support element (84, 91), the needles (85) of said plurality extending from the support element (84, 91) in such a way that the tips (86) of the needles (85) define a face having a plurality of perforating spikes,
the micro-holing device (83, 93) being designed to drive the needles (85) into the pasta food product (1, 2, 20) to make said plurality of micro-holes (83, 93) in the pasta food product (1, 2, 20).

10. Apparatus (8, 9) according to claim 9, wherein the micro-holing device (83, 93) comprises a heating system (87, 97) for heating the needles (85).

11. Apparatus (8) according to claim 9, including a support base (80) for the pasta food product (1, 2, 20),
the micro-holing device (83) being movable between a rest position, in which the needles (85) are away from said support base (80), and an operative position, in which the needles (85) are near to said support base (80),
the micro-holing device (83) in the operative position being designed to drive the needles (85) into a pasta food product (1, 2, 20) that is located on the support base (80).

12. Apparatus (9) according to claim 9, wherein the support element is a roller (91) rotatable about a respective longitudinal axis (910) and the needles (85) of said plurality extend radially from the lateral surface (915) of the roller (91), the micro-holing device (93) being designed to drive the needles (85) into a pasta food product (2, 20) during a rotation of the roller (91) about the respective longitudinal axis (910).

13. Pasta food product (1, 2, 20) according to claim 2, wherein each of said micro-holes (18, 28) has a diameter (D) which is between 0.1 mm and 0.6 mm.

14. Pasta food product (1, 2, 20) according to claim 13, wherein each of said micro-holes (18, 28) has a diameter (D) which is approximately 0.5 mm.

15. Pasta food product (1, 2, 20) according to claim 3, wherein said micro-holes (18, 28) are spaced from each other with a spacing (L) that is approximately 2 mm.
